(19) United States
(12) Patent Application Publication
(10) Pub. No.: US 2010/0082685 A1
(43) Pub. Date: Apr. 1, 2010

(54) SYSTEM AND METHOD FOR EVALUATION AND PRESENTING AUTHORIZATION RIGHTS IN AN ORGANIZATION

(76) Inventors: Hila BARR HOISMAN, Jerusalem (IL); Shimon Eitan Zimbalist, Beit Shemesh (IL); Asaf Koren, Moshav Haniel (IL); Anna Gilman, Jerusalem (IL); Yifat Ben Yaakov, Yavne (IL); Marina Segal, Tel-Aviv (IL)

Correspondence Address: Pearl Cohen Zedek Latzer, LLP, 1500 Broadway, 12th Floor, New York, NY, 10036, US

(21) Appl. No.: 12/235,755

(22) Filed: Sep. 23, 2008

(51) Int. Cl. G06F 17/30

(52) U.S. Cl. 707/785; 707/E17.059

(57) ABSTRACT

A system and method for evaluating instances of authorization authority or segregation of duties in an organization against criteria for such authorizations, storing results of such evaluations and presenting such results to a user through queries of the stored results.

### FIELD OF THE INVENTION

The present invention generally relates to enterprise resource planning systems. More particularly, the present invention relates to a system and method for evaluating authorization and access rights, and presenting results of such evaluation.

### BACKGROUND OF THE INVENTION

Organizations such as corporations, partnerships, governments and others may adopt policies for approving or authorizing certain actions on behalf of the organization. Such actions may include for example check writing, purchase order execution, hiring decisions, access to data, access to accounts and others. The organization may assign approval authority or access rights to various individuals and may keep in an enterprise resource planning (“ERP”), data that relate to those access rights that may include for example a list of individuals, the authorization level held by such individual, the areas of the organization to which such authorization applies, and other constraints.

A review of compliance of the grants of authorizations or access rights with the policies adopted by the organization may be performed on a periodic or regular basis, and may include evaluation of compliance of the granted authorizations with the adopted policies. Some reviews may evaluate compliance of granted authorizations or access rights with a standard or ‘best practice’ that may be used by for example auditors to evaluate procedures, policies and compliance in many companies.

Evaluation of compliance of an organization with authorization or access policies may be a complicated process that may involve formulation of separate queries or the implementation of separate analytical steps for each evaluation to be reviewed.

### SUMMARY OF THE INVENTION

Some embodiments of the invention include an enterprise resource planning system having a data base that stores a series of authorization criteria for actions of an organization, and a series of instances in the organization that satisfy the authorization criteria. The criteria may relate for example to a grant of access rights to data of the organization or to taking actions on behalf of the organization. For example, an instance may include one or more set of actions performed by an entity or organization, one or more individuals in an organization, one or more transactions performed by an organization or other items or functions. The system may include a memory that stores an evaluation protocol which compares instances that satisfy the criteria against a series of practices. For example, a practice may include any set of established and/or documented actions or procedures(s) performed as instances. The evaluation protocol is initiated by another component of the system, viz., a processor. The processor, in connection with the database performs the following steps: generates a series of results of the evaluations; accepts a request from a user to retrieve a stored result from the series of results; and generates a display of the result for the requested instance.

In some embodiments, the instances may include for example individuals in the organization, divisions of the organization or functions of the organization.

In some embodiments, the evaluation may include compliance with suggested practices for limiting access to data. For example, a protocol may evaluate whether the access to data that were granted to a particular individual or instance is compliant with a suggested practice for limiting access to data by a particular individual.

In some embodiments, the processor is to generate results for all relevant instances.

In some embodiments, the criteria includes model or best practices criteria suitable for analyzing organizations.

In some embodiments, the processor is to accept a request for a result of an evaluation in QlikView.

In some embodiments, the enterprise resource planning system compatible with an Oracle application system or with an SAP system.

Some embodiments of the invention include a method of evaluating rights that were granted to an instance such as an individual, where such rights include for example access rights to data or rights to perform duties on behalf of an organization against authorization policies; storing results of the evaluations; accepting from a user a selection of an instance; and displaying a result for the instance from among the stored results.

Some embodiments may include storing the results as responses to pre-formulated queries.

Some embodiments may include retrieving an instance from an ERP system, where the ERP is compatible with for example an SAP system or an Oracle Application system.

Some embodiments may include evaluating application of policies of an organization against a standard. For example, a policy of an organization may dictate that a particular level of manager is to have access to a particular category of information. A comparison of such policy to a best practices for access to data may be made in respect of a series of individuals in an organization.

In some embodiments, evaluations may be stored for all relevant instances.

In some embodiments, the evaluation may include evaluating compliance with suggested practices for limiting authorizations to take actions on behalf of the organization.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof may best be understood by reference to the following detailed description when read with the accompanied drawings in which:

FIG. 1 is a block diagram of components of a system in accordance with an embodiment of the invention; and

FIG. 2 is a flow chart of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “comparing”, “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Unless set forth explicitly otherwise, embodiments of the invention described herein are not described with reference to any particular programming language, machine code, network etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention

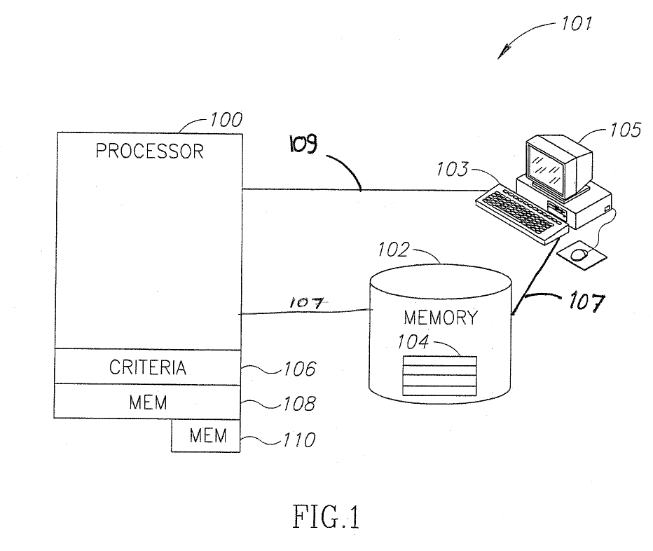

Reference is made to FIG. 1, a block diagram of a system in accordance with an embodiment of the invention. In some embodiments a system 101 may include a processor 100 that may be connected to or included in a computer such as a mainframe, mini-computer or series of networked personal computers. Other processors may be used. Memory 102 may include a memory that includes a structured storage or other mass data storage or data base 104 such as those that may be represented by or used in an ERP system. The database 104 may be part of memory 102 as shown in FIG. 1 or at least the memory 102 has access to the database 104 to retrieve and/or process information stored in the database 104. Processor 100, which is linked to the memory 102 and thus the database 104, may be linked to or included in a computer system that may include for example a display 105, one or more input devices 103 such as a key board or mouse, memory 102 and other components. In some embodiments, processor 100 and data base 104, as may be represented by or used in an ERP system, may be linked to a network. The network may be or include for example a local area network, a wide area network or other networked configurations. As shown processor 100 is connected to database 102 via link 107 through which processor 102 is able to store and/or retrieve data from memory 102 including database 104. Also, processor 100 is able to control display 105 via link 109. The links 107 and 109 may be communication links implemented in various manners including but not limited to wireless links, wired links, and fiber optic links.

In some embodiments, database 104 or ERP system may include one or more collections of data or lists relating to for example individuals, tasks, levels of authority, access grants, levels of expertise, approval requirements, transaction records, records of approvals of transactions and other data. In some embodiments database 104 or ERP system may include associations between one or more transactions or instances in the data base, the individuals who approved such transactions, the level of authority held by such individuals, a particular policy or criteria of an organization under which such individual was granted such authority, a result of the transaction, a reviewing party for such transaction and one or more comments about the transaction. In some embodiments, database 104 or ERP system may include a list of authorities that may be granted to an individual, such as authority to open a vendor account, authority to authorize a purchase from a vendor and authority to authorize payment to a vendor. Database 104 may also include access rights to data as may be granted to various individuals. Other lists of data may be included and other associations are possible. In some embodiments, database 104 may be included in an enterprise resource planning system such as those provided by companies such as SAP™, Oracle™ and others.

In some embodiments, memory 102 or another storage device may have stored therein one or more criteria 106 that may be applied to some or all data stored in database 104, and upon which such data may be evaluated. Criteria 106 may be stored as a series of tests or evaluations that represent recommendations, model practices or established industry standards to which the data in database 104 may be compared, and by which one or more policies or executions of policies by an organization may be graded as either satisfying the relevant criteria or failing to satisfy such criteria.

In operation, on a periodic basis or at selected times, processor 100 may execute instructions that collect relevant data from database 104, and evaluate such data for compliance with the industry standards or best practice rules that may be stored in memory 102. The results of such evaluation for all or some designated part of the relevant data may be stored in memory 102 or in another memory. A user of the system may view such stored results through an application such as QlikView or other business intelligence tools, and may parse through the stored results rather than formulating a query for each requested evaluation and waiting for a response to such query to be collected by the application. In some embodiments, such best practices may relate to separation of authority, grant of access or segregation of duties policies in an organization, to data security, to data access or to other policies.

In some embodiments, a use of the system may follow the following scenario: a company may have adopted a policy under which entry of data about a supplier into a master supplier list may be performed only by staff of an accounting division, and such entry must be confirmed by a manager of such division. Similarly, entry of data for a payment authorization to a supplier may be performed only by a member of the accounting division, and such entry must be confirmed by a manager of such division.

For the industry in which the company operates, a standard or recommended practice may dictate that the accounts manager who confirms the entry of new supplier data should not be the same accounts manager who confirms the entry of supplier payment data. Furthermore, the standard practice may also dictate that at least once during each quarter, the accounts department must call the supplier to confirm the shipment of goods and the receipt of payment.

Database 104 may include a listing of individuals who are authorized to enter new supplier data and who are authorized to approve entry of such data. The list includes several members of the accounting staff, Mr. Jones and Mr. Smith, and Mr. Anderson who is a manager of the accounting division.

As part of for example an annual audit of the company, processor 100 of system 101 may collect from database 104 all information relating to all personnel who are authorized to enter new supplier data into the company's system and all managers who may authorize payments to such suppliers. The relevant information may be loaded into for example a temporary memory 108 that can be searched. Processor 100 may evaluate all of the loaded information under for example both the company's own policy and the industry standard or best practices criteria. The results of all such evaluations may be stored in for example another temporary memory 110. Although shown as being memories separate from memory 102, memory 108 and memory 110 may be part of memory 102.

In some embodiments, the results of the evaluations and application of the relevant company policies or best practices to actions taken by the company may be graded by various metrics. Such results may be collected for the organization as a whole, for a particular policy adopted by the company, for a particular industry best practice, for a particular type of transaction such as a purchase order, or for a particular manager or supplier. Other breakdowns of ratings and evaluations are possible so that a person who is reviewing the test results may drill down into the details of the evaluations to see which transactions, processes, policies or individuals contributed to the evaluation results. In some embodiments, an evaluation of a segregation of duties policy may be graded as a level of sensitivity to abuse from within an organization, where the possibility or likelihood of abuse may differ among individuals, divisions or processes in an organization. The capability of drilling down to individual instances or processes that present an increased risk of abuse is therefore beneficial. Similarly, a graphic display of the possible conflicts among or abuses of authority is helpful in evaluating the organization's compliance with policies.

Returning to the example above, an evaluation of the company's authorizations as compared both to the company's own policies and to an industry standard or ‘best practices’, may be initiated by for example loading all relevant authorizations and transactions from database 104 into memory 108. Such data may include the authorizations that were granted to each of Mr. Jones, Mr. Smith and Mr. Anderson. Processor 100 may evaluate the authorizations, entries of data, purchase orders and confirmations during a period to determine or rank compliance with for example the company policy that the accounts manager that confirms new supplier data should not be the same accounts manager that confirms payments made to supplier. Similarly, processor 100 may evaluate compliance with the industry best practice that only a manager of the accounting division is authorized to confirm an entry of data for a payment. The results of such evaluation for the relevant payments and entries of data, for the relevant suppliers and in respect of all the relevant approving company officers may be stored in temporary memory 110. For example, in some embodiments, processor 100 may store for each individual in an organization, a list of the authorizations or access grants to such individuals, and the conflict of such authorizations with a company policy. For example, the evaluation may determine that Mr. Anderson is authorized to confirm data about new suppliers that is entered by Mr. Smith, and data about payments to such new suppliers that is entered by Mr. Jones. The system 101 may flag such authorizations as not complying with the industry best practices. Similarly, processor 100 may evaluate all authorizations for purchase order transactions in a relevant data base and assemble all individuals that are authorized to create, change or approve purchase orders in accordance with recommended industry standards or best practices. The results of such evaluation may be stored in temporary memory 110.

In some embodiments, the test result data may be viewed or displayed in for example a QlikView™ format so that the drill down into levels of data or evaluations of each of a series of managers or transactions need not be accompanied by a new data base query. Rather, the storage of the test results in memory 110, and their accessibility using QlikView, enables a user to parse through numerous or all results that are stored in memory 110 without formulating separate queries for each result to be viewed. In some embodiments, one or more queries may be written into a graphic user interface (GUI) so that a user may sort through results by inserting a name or other variable into a selection box on a screen, and view all of the test results that were stored in temporary memory 110 about such selection. Further sorts are available to a user by inserting other constraints in a dialog box of the GUI. For example, a user may enter a division of the company into a dialog box on the GUI, and select a type of purchase order as a constraint for such division. Processor 100 may retrieve some or all of the relevant authorizations regarding purchase orders granted to the named division, and may provide a rating or scoring of the compliance by the named division with the company's policies relating to purchase order authorization. A user may select another constraint such as the name of a manager in such division, and processor 100 may retrieve and display a scoring of the authorizations or data access rights granted to such manager and any conflicts or potential abuses posed by such authorizations. Further constraints may be added so that a user may drill down to for example a particular transaction and receive a rating or scoring of the transaction against company policies or best practices.

In some embodiments, data stored in temporary memory 110 may be compared to similar data that was collected in a prior period, and an analysis of the performance in a first period to performance in a second period may be made.

In some embodiments, an analysis of exposure to risk of unauthorized activity, improper authorizations, insecurely stored data or other policy failures may be made by identifying an authorization that is in conflict with a policy, calculating a number of individuals in an organization that are subject to such conflict and evaluating the risk to the organization that is posed by the conflict. For example, the system may display and enable analysis of users who were assigned authorizations which create conflicts regarding the suppliers' master data maintenance and the payments to Suppliers. Such conflict may expose the organization to a situation where a user can create a fictitious supplier with his own bank account and pay a fictitious invoice.

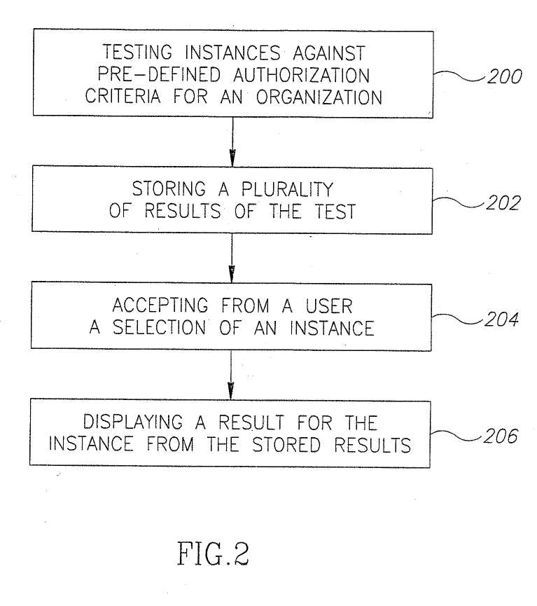

Reference is made to FIG. 2, a flow diagram of a method in accordance with an embodiment of the invention. In block 200, instances of actions by an organization may be evaluated in accordance with a series of checks or protocols to determine compliance with authorization criteria of an organization. For example a plurality of instances may be evaluated against authorization criteria for segregation of duties in an organization. In block 202, the result of such evaluations for some or all of the instances may be stored in a memory. In block 204, a processor may accept a request from a user for display of results for one or more instances that may be found in the ERP, as such results are stored in the memory. In block 206, a requested result may be displayed to the user.

It will be appreciated by persons skilled in the art that embodiments of the invention are not limited by what has been particularly shown and described hereinabove. Rather the scope of at least one embodiment of the invention is defined by the claims below.

We claim:

1. A system comprising:
a data base having stored thereon:
a plurality of authorization criteria for actions of an organization; and
a plurality of instances in said organization that satisfy said criteria;
a memory with access to the database, and said memory having stored therein an evaluation protocol to compare said instances that satisfy said criteria against a plurality of practices; and
a processor, in connection with the memory, to:
generate a plurality of results of said evaluations for storage in the memory;
accept a request from a user to retrieve from said memory a result of said plurality of results for an instance from among said plurality of instances; and
generate a display of said results for said instance from among said plurality of instances.

2. The system as in claim 1, wherein said instances are selected from the group consisting of individuals in said organization, sub-structures of said organization and functions of said organization.

3. The system as in claim 1, wherein said evaluation comprises compliance with a suggested practice for limiting access to data.

4. The system as in claim 1, wherein said processor is to generate results for all of said instances.

5. The system as in claim 1, wherein said criteria comprise model criteria suitable for testing a plurality of organizations.

6. The system as in claim 1, wherein said processor is to accept said request in QlikView.

7. The system as in claim 1, wherein said database or ERP comprises a data base compatible with an Oracle application system.

8. The system as in claim A1, wherein said system is compatible with an SAP system.

9. A method comprising:
evaluating a plurality of instances against authorization criteria for segregation of duties in an organization;
storing a plurality of results of said evaluations;
accepting from a user a selection of an instance from said plurality of instances; and
displaying a result for said instance from among said plurality of stored results.

10. The method as in claim 9, further comprising storing said results as responses to pre-formulated queries.

11. The method as in claim 9, further comprising
retrieving said instances from a data base selected from the group comprising an SAP compatible data base and an Oracle ERP compatible system; and
converting said instances into a text file.

12. The method as in claim 11, further comprising evaluating said policies of said organization against an established standard.

13. The method as in claim 9, wherein said storing comprises storing evaluation results for all of said instances.

14. The method as in claim 9, wherein said evaluating comprises evaluating compliance with suggested practices for limiting authorizations to take actions on behalf of said organization.
